(19) United States
(12) Patent Application Publication
(10) Pub. No.: US 2005/0044377 A1
(43) Pub. Date: Feb. 24, 2005

(54) Method of authenticating user access to network stations

(76) Inventor: Yen-Hui Huang, Taipei Hsien (TW)

Correspondence Address: DELLETT AND WALTERS, P. O. BOX 2786, PORTLAND, OR, 97208-2786, US

(21) Appl. No.: 10/643,721

(22) Filed: Aug. 18, 2003

(51) Int. Cl. H04L 9/00

(52) U.S. Cl. 713/182

(57) ABSTRACT

A method of authenticating a user access to network stations is disclosed. Users of the new authentication system do not need to input passwords to gain access to the network stations for on-line transactions, as the authentication job is handled by the authentication server and the net entry apparatus through a host computer. A token is generated dynamically and sent to the application server to which the user intends to gain access, and the verification process is then activated between the authentication server and the application server, which then retrieves a symmetrical copy of the token to compare with the token passed from the application server. If both tokens match up, the user ID has passed the security check. Users are freed from having to memorize different user IDs and passwords to operate many network accounts, with no risk of losing network account numbers and passwords.

### BACKGROUND OF THE INVENTION

1. Field of the Invention

The present invention relates to a method of authenticating user access to network stations, especially to an authentication method making use of a net entry apparatus possessing a cryptography security mechanism to establish two-way communication with an authentication server and an application server through a host computer, whereby a machine-independent token is generated and sent to the application server for verification of a user ID to control access to specific network station for on-line transactions. This authentication system is able to enhance Internet security by obviating the input of user IDs and passwords by users, thus freeing users from having to memorize many different passwords and minimizing the risk of account numbers and passwords being stolen.

2. Description of Related Arts

Internet services are expanding rapidly because the Internet technology has created an information super highway across national and geographical boundaries. Network users are able to conduct a variety of on-line transactions through network computers, notebook computers, and the latest cellular phones, realizing the dream of virtual offices and real-time transactions through the Internet.

Many kinds of network services have been developed over the past years, such as electronic commerce, electronic shopping, network games, and network financial services. However, these new forms of network activities also give rise to network crimes and security problems. As an example, network games have gained wide popularity in the Asian region, but the crime rate of stealing account numbers and passwords is also rising fast. The perpetrators are somehow able to intercept the personal information of game players through the network connections, no matter the players are playing at home or in a network cafe. Thus far, there has been no effective means to prevent the stealing of account numbers and passwords.

In network financial services. many people have used on-line services offered by financial institutions to handle their personal financial affairs for work efficiency and to gain access to the resources available on the Internet. These on-line services range from network banking, transfers of funds, payment of utility bills, to stock transactions. Nevertheless, for all these services, users still need to apply for the right to access the network services by filling out many personal data forms to verify their user IDs. Furthermore, users have to enter their user IDs and passwords each time when they want to gain access to the network stations. In some ways, users may have to take the risk of exposing their personal information to other persons in the process of inputting user IDs and passwords.

At present, most software programs of network banking are installed with SSL 128-bit high compression security encryption and are certified by international institutions to enhance Internet security. Yet, in many instances, the user's operation to gain access to the network services is not very user friendly. For ease in memorization, many users simply use one set of password and user ID for all network accounts. If a perpetrator is able to steal that set of user ID and password, then the thief can break into all network accounts with the same user ID without further checks. On the other hand, if the user sets up different user ID and passwords for different accounts. then this will require memorization of many numbers, which might not be easy as the opportunity of using user IDs and passwords to access network services gets higher every day. Therefore, the public demands a more user-friendly operation to access network stations.

### SUMMARY OF THE INVENTION

The main object of the present invention is to provide a method of authenticating user access to network stations for on-line transactions, obviating the input of user IDs and passwords by users, yet ensuring Internet security.

To this end, the instrumentalities of the present invention include a two-stage authentication process. The first-stage authentication includes the establishing of two-way communication between a net entry apparatus possessing the cryptography security mechanism and an authentication server through a host computer, whereby the authentication server generates a network key after verifying the identity of the net entry apparatus, comprising the steps of
activating the user ID authentication mechanism;
reading off the basic data or user ID of the net entry apparatus by a host computer and sending them to the authentication server;
sending a random number test key, by the authentication server, back to the net entry apparatus within a preset time, and keeping a copy of the random number test key in the authentication server;
encrypting the received test key with a private key embedded in the net entry apparatus and then sending the encrypted data back to the authentication server;
retrieving the other copy of the random number test key for encryption with a symmetrical copy of the private key by the authentication server and comparing it with the encrypted data received from the host computer; if the two test keys correspond with each other, the authentication server then generates a network key.

The second-stage authentication starts after the generation of the network key, comprising the steps of:
encrypting a token with the network key, by the authentication server, and then sending the encrypted token to the host computer;
sending the encrypted token, by the host computer, to an application server for intended on-line transactions;
receiving the encrypted token, by the application server, and passing it to the authentication server for verification;
decrypting the token received, by the authentication server, and then comparing it with the original token; and
informing the application server that the user ID is valid, if the tokens correspond with each other; otherwise the user ID is invalid if the tokens do not match.

The second object of the present invention is to provide a net entry apparatus having the capability of creating cryptography security, comprising:
a microprocessor for internal computation;
a connection interface for linking up with the host computer;
an encryption unit for generating encrypted data; and
a system memory for temporarily saving of a user ID from the net entry apparatus and the random number test key.

The above-mentioned microprocessor, in accordance with the present invention, is equipped with RISC capability.

The above-mentioned connection interface, in accordance with the present invention, has a USB 1.1 interface.

The above mentioned encryption unit, in accordance with the present invention, employs a high compression security standard of AES 128-256 bits or a regular security standard complying with RSA, DES, 3DES, MD5, MD2, and SHA-1.

The above mentioned system memory, in accordance with the invention, can be formed by read-only memory, dynamic random access memory, and erasable programmable read-only memory.

The features and structure of the present invention will be more clearly understood when taken in conjunction with the accompanying figures.

### BRIEF DESCRIPTION OF THE DRAWINGS

FIG. 1 system architecture of a possible implementation of the present invention;

FIGS. 2-4 show a flow chart of the authentication process of the present invention; and

FIG. 5 is a block diagram of a net entry apparatus for the present invention.

### DETAILED DESCRIPTION OF THE PREFERRED EMBODIMENT

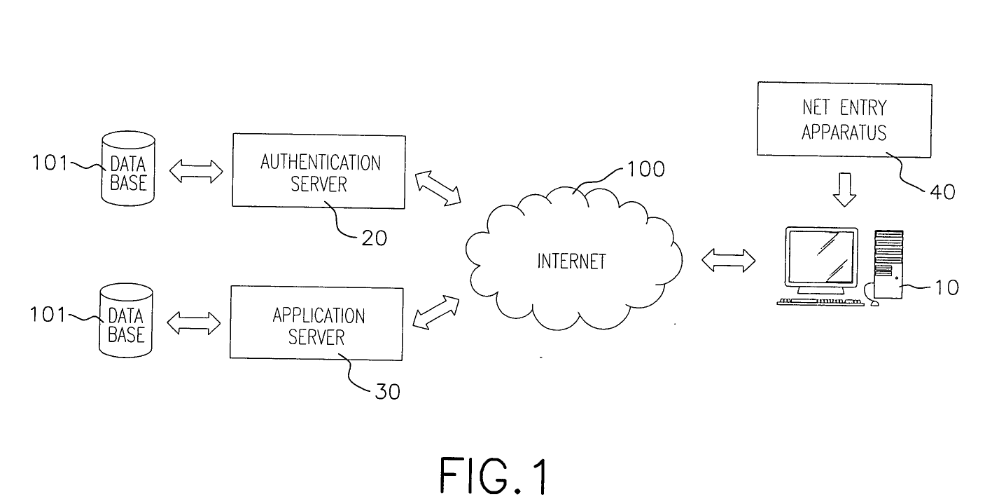

The architecture of the authentication system, as shown in FIG. 1 includes a host computer (10), an authentication server (20), an application server (30) and a net entry apparatus (40). The authentication process is activated when the application server (30) needs to verify the user ID, whereby the net entry apparatus (40) possessing the cryptography security mechanism is connected to the authentication server (20) through the host computer (10).

The host computer (10) is used to establish two-way communication with the authentication server (20) through the network connection to obtain a network key after successful verification of the user ID. In the process, a token is generated by a dynamic process, which is then passed to the application server (30). The application server (30) is a network station on the Internet to which the user intends to gain access. The net entry apparatus (40) is also linked with the application server (30) through the host computer (10) for verifying the token sent by the host computer (10).

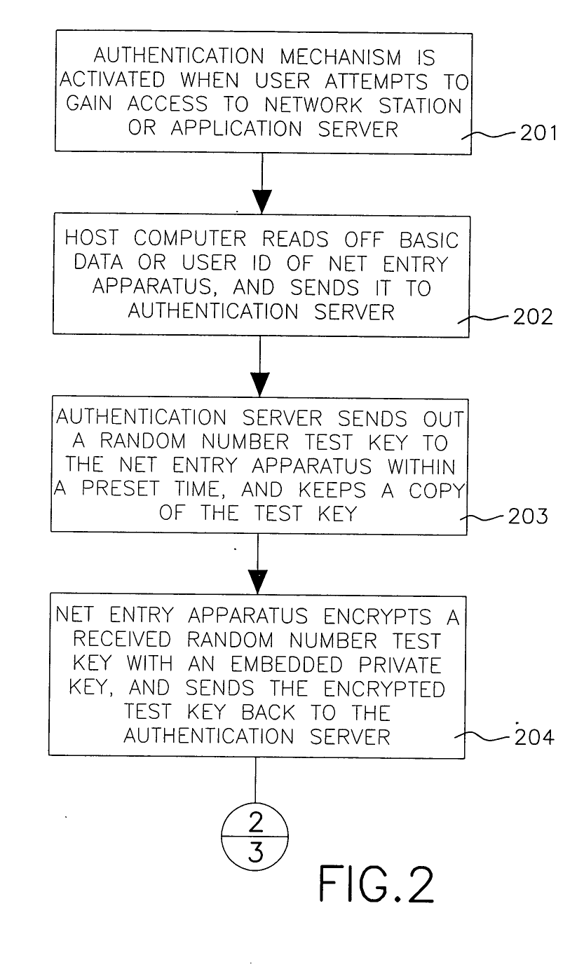

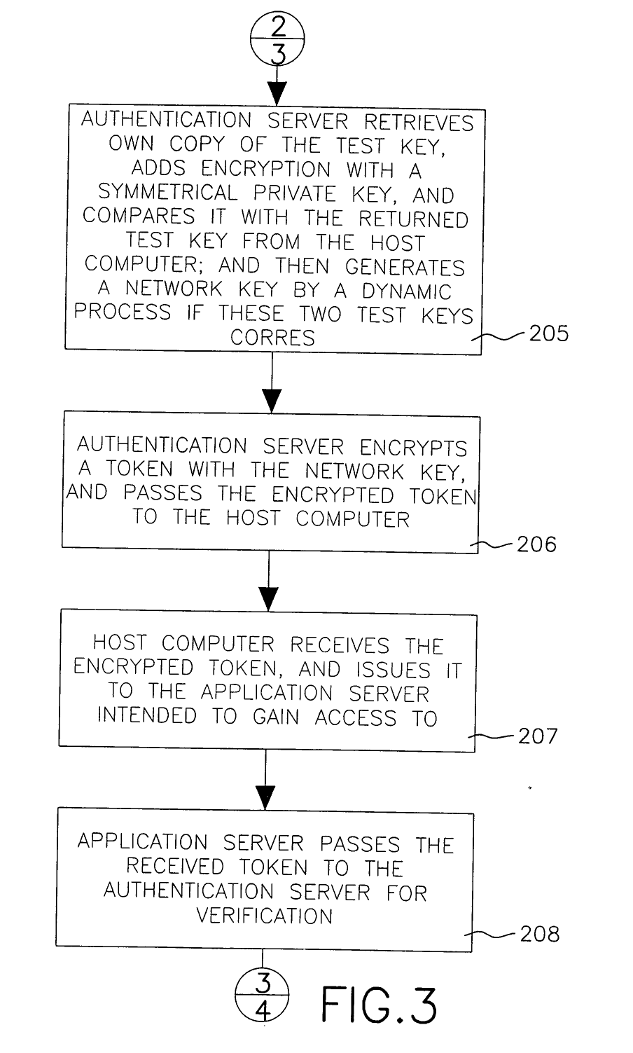

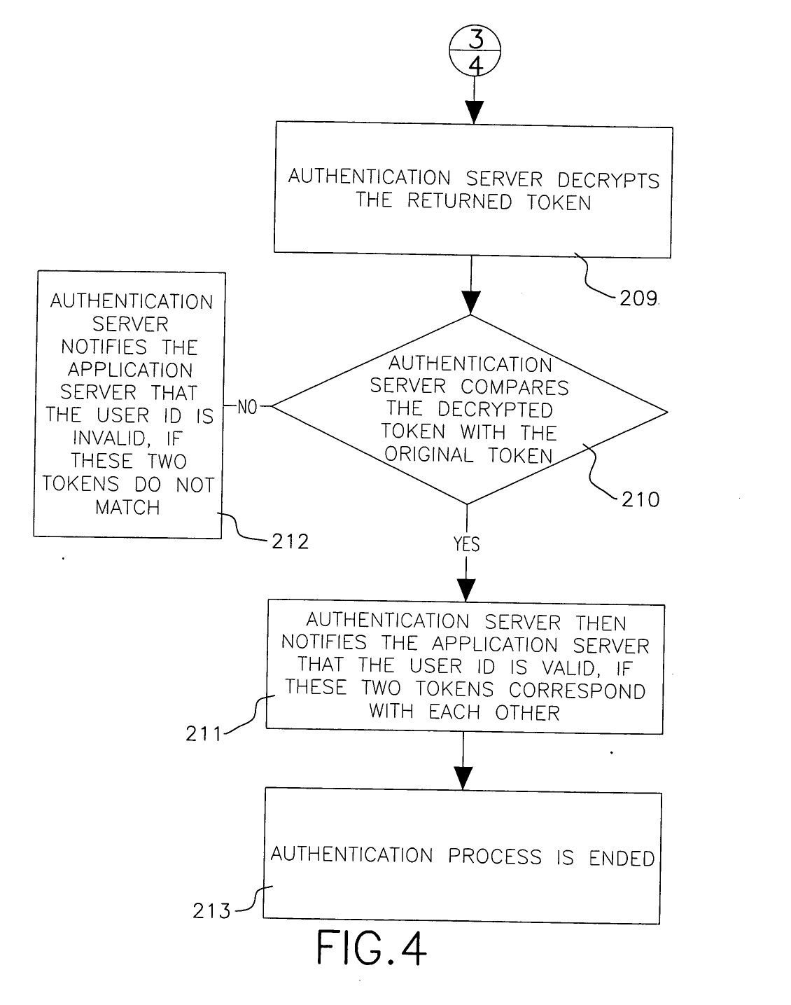

The authentication is a two-stage process. The first stage authentication process, as shown by FIGS. 2-4, includes the steps of:
activating the authentication mechanism, by the authentication server (20), when a user attempts to gain access to a network station or application server (30) with a net entry apparatus (40) (201);
reading off the basic data or user ID of the net entry apparatus (40), by the host computer (10), and sending the user ID over the Internet to the authentication server (20) (202);
sending out a random number test key to the net entry apparatus (40), by the authentication server (20), on receiving the user ID of the net entry apparatus (40), within a preset time, and keeping a copy in the authentication server (20) (203), wherein the contents of the random number test key are created by a random process;
encrypting the received random number test key, by the net entry apparatus (40), with an embedded private key, after the host computer (10) has received the random number test key from the authentication server (20), and sending the encrypted random number test key back to the authentication server (20) (204); wherein the above net entry apparatus (40) can employ a high compression security standard of AES 128-256 bits or a regular security standard complying with RSA, DES, 3DES, MD5, MD2, and SHA-1;
retrieving an own copy of a random number test key for encryption with a symmetrical private key, by the authentication server (20), and then comparing it with the encrypted random number test key sent from the host computer (10); and then generating a network key dynamically, by the authentication server (20), if the two test keys correspond with each other (205), wherein each network key is unique and will be automatically deleted after a certain time.

The above-mentioned process represents the first stage authentication of user identification conducted between the host computer (10) and the authentication server (20). The second stage authentication starts after the generation of the network key, as shown in FIGS. 2-4, including the steps of:
encrypting a token with the network key, by the authentication server (20), and passing the encrypted token to the host computer (10) (206);
receiving the encrypted token, by the host computer (10), and passing it to the application server (30) intended to gain access for on-line transactions (207);
passing the received token to the authentication server (20), by the application server (30), for verification (208);
decrypting the returned token, by the authentication server (20) (209);
comparing the decrypted token with the original token (210);
sending a message to the application server (30) notifying that the user ID is valid, if the two tokens correspond with each other (211); otherwise, the user ID is invalid, if the two tokens do not match (212).

The important feature of the present invention is that the user requesting access to an application server (30) for on-line transactions does not need to input a user ID and password in the authentication process; instead, only a net entry apparatus (40) has to be used to link up with a host computer (10), through which a two-way communication is established with the authentication server (20) and the application server (30). The authentication mechanism is activated by the application server (30) that needs to verify the user ID of the net entry apparatus (40), which is connected to the authentication server (20) through the host computer (10). In the authentication process, a set of test key, network key and token is generated by the authentication server (20) and passed back to the host computer (10). One copy of the token is issued to the application server (30) through the host computer (10), and the other copy is kept by the authentication server (20). When the application server (30) receives the token, the application server (32) returns the token to the authentication server (20) for verification. Then, the authentication server (20) retrieves the original token to compare with the returned token. Then, the application server (30) is notified of the validity of the user ID.

Since the user does not need to input the user ID and password when trying to access the network station or application server, the authentication system can prevent stealing or intercepting of user IDs and passwords by unauthorized persons.

When the user attempts to gain access to a different network station, the above mentioned authentication process will be performed all over again, and a new set of random number test key, network key and token will be generated in another authentication process, but the user does not need to use different user IDs and passwords to operate network accounts on different systems. The authentication system has the advantages of freeing users from having to memorize many different numbers and preventing the stealing of user IDs and passwords for criminal purposes.

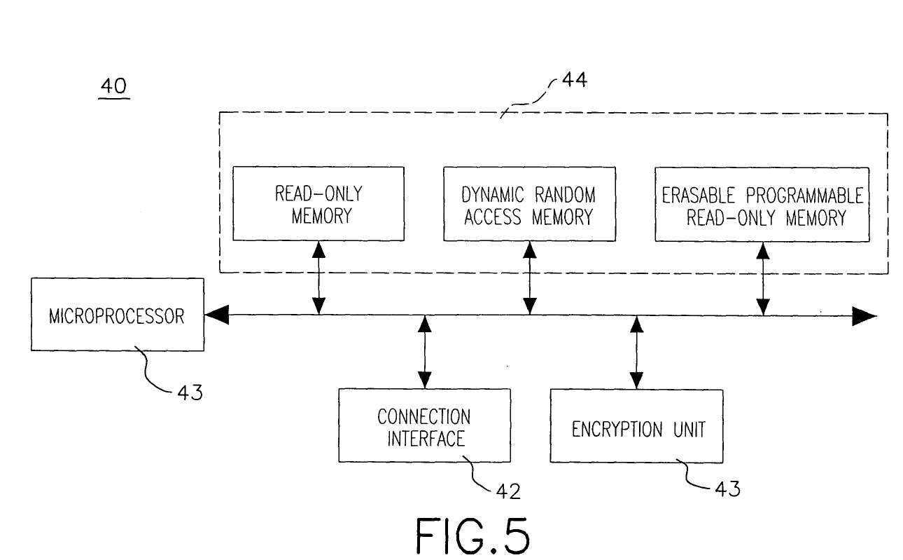

The above-mentioned net entry apparatus (40) can be implemented as shown in FIG. 5, comprising:
a microprocessor (41) for encryption of data, being equipped with RISC capability, but it can also be implemented with a low-end processor to reduce costs;
a connection interface (42) having a USB 1.1 interface for linking with a host computer (10);
an encryption unit (43) for creating encrypted data, wherein the encryption unit can be installed with a high compression standard of AES 128-256 bits or a regular security standard complying with RSA, DES, 3DES, MD5, MD2, and SHA-1;
a system memory (44) for temporarily saving of a user ID of the net entry apparatus (40) and the random number test key, wherein the system memory can be formed by read-only memory, dynamic random access memory, and erasable programmable read-only memory.

Since the net entry apparatus (40) is equipped with a USB interface, it does not need a card reader as in those systems operated by a contact/non-contact memory cards, IC cards, smart cards, etc. Since most personal computers and notebook computers can support a USB interface, and the net entry apparatus (40) is compatible with an HID interface, the net entry apparatus (40) has plug-and-play characteristics, that means the authentication system can be up and running without needing software drivers, making it simpler to operate than conventional contact/non-contact memory cards, IC cards, or smart cards.

The present invention is also characterized in that each net entry apparatus has a unique digital signature, representing the user ID that cannot be duplicated. Each net entry apparatus is embedded with a private key that contains a long bit string that is burnt into the processor using a chip programmer. After writing in the necessary data, a large current is applied on the I/O pins of the chip to break off all connection points to make the chip isolated from outside circuits. In the key burning process, only the authentication server possesses a copy of the private key corresponding to the private key in the net entry apparatus. The only way to obtain the user ID stored in the net entry apparatus is to use a computer with a USB connection interface to read off the data from the net entry apparatus that has to be decrypted with the private key.

For extra protection and for users accustomed to the conventional authentication systems, an initial password can be used to activate the net entry apparatus, which is not to be transmitted over the network. An initial password is only required when the net entry apparatus links up with a host computer, and only when the initial password check is passed is the net entry apparatus then able to make a request to access an application server.

From the above description, the design of the net entry apparatus, in accordance with the present invention, is also suitable for many different applications, such as checking of player identification in network games, secured electronic documents for government offices, secured electronic banking services and electronic commerce, management of a patient's medical history, and authentication of user access to national and military entities.

The foregoing description of the preferred embodiments of the present invention is intended to be illustrative only and, under no circumstances, should the scope of the present invention be so restricted.

1. A method of authenticating a user ID by making use of a net entry apparatus (40) possessing a cryptography security mechanism to establish two-way communication with an authentication server (20) and an application server (30) through a host computer (10), involving a two stage authentication process, wherein
the first-stage authentication is conducted between the net entry apparatus (40) and the authentication server (20), whereby the authentication server (20) obtains the basic data or user ID from the net entry apparatus (40) to generate a random number test key, and then sends it to the net entry apparatus (40); then the net entry apparatus (40) encrypts the test key with an embedded private key and sends it back to the authentication server (20); then the authentication server (20) retrieves its own copy of the test key, adds an encryption with a symmetrical test key, and compares it with the test key received; then if these two test keys correspond with each other, the authentication server (20) generates a network key and sends it to the host computer (10);
the second-stage authentication is conducted after the network key is received by the authentication server (20), whereby the authentication server (20) generates an encrypted token with the network key and sends it to the host computer (10); then the host computer (10) issues the encrypted token to the application server (30) to which the user intends to gain access; then the application server (30) receiving the encrypted token passes it back to the authentication server (20) for verification; then the authentication server (20) decrypts the returned token with the network key and compares it with the original token; then if the two tokens correspond with each other, the authentication server (20) notifies the application server (30) that the user ID is valid; otherwise, the user ID is invalid if these two tokens do not match.

2. The method of authenticating a user ID as claimed in claim 1, wherein the first stage authentication further includes:
activating the authentication process;
reading off the basic data or user ID of the net entry apparatus (40), by the host computer (10), and sending it to the authentication server (20);
generating a random number test key, by the authentication server (20), on receiving the user ID of the net entry apparatus (40) and keeping a copy of the random number test key;
encrypting the random number test key using the private key of the net entry apparatus (40), and sending it to the authentication server (20);
retrieving own copy of random number test key, by the authentication server (20) for encryption with the symmetrical copy of the private key, and comparing it with the received test key;
generating a network key, by the authentication server (20), if the two test keys correspond with each other (20).

3. The method of authenticating a user ID as claimed in claim 2, wherein the second stage authentication further includes:
using the network key generated in the first stage authentication to encrypt a token, by the authentication server (20), and passing the encrypted token to the host computer (10);
sending the encrypted token to the application server (30) from the host computer (10);
passing the encrypted token to the authentication server (20) for verification when the application server (30) receives the encrypted token;
decrypting the token with the network key, by the authentication server (20), and comparing it with the original copy of token;
notifying the application server (30) that the user ID is valid for the intended on-line transactions, if these two tokens correspond with each other; or the user is invalid if these two tokens do not correspond.

4. The method of authenticating a user ID as claimed in claim 1, wherein the private key embedded in the net entry apparatus (40) and maintained by the authentication server (20) is created with a high compression security standard of AES 128-256 bits.

5. The method of authenticating a user ID as claimed in claim 2, wherein the private key embedded in the net entry apparatus (40) and maintained by the authentication server (20) is created with a high compression security standard of AES 128-256 bits.

6. The method of authenticating a user ID as claimed in claim 3, wherein the private key embedded in the net entry apparatus (40) and maintained by the authentication server (20) is created with a high compression security standard of AES 128-256 bits.

7. The method of authenticating a user ID as claimed in claim 1, wherein the private key embedded in the net entry apparatus (40) and maintained by the authentication server (20) is created with regular security standards complying with RSA, DES, 3DES, MD5, MD2, and SHA-1.

8. The method of authenticating a user ID as claimed in claim 2, wherein the private key embedded in the net entry apparatus (40) and maintained by the authentication server (20) is created with regular security standards complying with RSA, DES, 3DES, MD5, MD2, and SHA-1.

9. The method of authenticating a user access to network stations as claimed in claim 3, wherein the private key embedded in the net entry apparatus (40) and maintained by the authentication server (20) is created with regular security standards complying with RSA, DES, 3DES, MD5, MD2, and SHA-1.

10. A net entry apparatus (40) for use in authentication, comprising:
a microprocessor (41) for internal computation;
a connection interface (42) for linking up with the host computer (10);
an encryption unit (43) for creating encrypted data;
a system memory (44) for temporarily saving of user ID of the net entry apparatus (40) and random number test key.

11. The net entry apparatus as claimed in claim 10, wherein the microprocessor (41) is built in with RISC capability.

12. The net entry apparatus as claimed in claim 10, wherein the connection interface (42) has a USB 1.1 or a higher specification.

13. The net entry apparatus as claimed in claim 10, wherein the encryption unit (43) is created with high compression security standards of AES 128-256 bits.

14. The net entry apparatus as claimed in claim 10, wherein the encryption unit (43) is created with regular security standards complying with RSA, DES, 3DES, MD5, MD2, and SHA-1.

15. The net entry apparatus as claimed in claim 10, wherein the system memory (44) is built with a read only memory, dynamic random access memory, and erasable programmable read-only memory devices.
